(19) United States
(12) Patent Application Publication
(10) Pub. No.: US 2026/0220907 A1
(43) Pub. Date: Jul. 30, 2026

(54) PROCESSING HOLLOW CORE FIBER IMAGES

(71) Applicants: Microsoft Technology Licensing, LLC, Redmond, WA (US); University of Southampton, Southampton (GB)

(72) Inventors: Ron FATOBENE ANDO, Romsey (GB); Marcelo BOTELHO ALONSO, Chandlers Ford (GB); Gregory JASION, Southampton (GB)

(21) Appl. No.: 19/342,295

(22) Filed: Sep. 26, 2025

Related U.S. Application Data
(60) Provisional application No. 63/750,985, filed on Jan. 29, 2025.

(51) Int. Cl. G06V 10/60; G06T 7/13; G06T 7/60; G06V 10/32; G06V 10/34

(52) U.S. Cl. CPC G06V 10/60; G06T 7/13; G06T 7/60; G06V 10/32; G06V 10/34; G06T 2207/20044

(57) ABSTRACT

A method for processing an image of a hollow core fiber, HCF, is described. For an edge of a tube of the HCF, brightness of the image is used to detect points corresponding to the edge. The method further includes fitting an edge model function to detected edge points, and identifying an outlier point of the detected edge points that is above a threshold distance from the fitted model. The outlier point is removed and the model is refitted to the remaining points. The method comprises iteratively identifying and removing subsequent outlier points and refitting the model to remaining points until all remaining points are inlier points below a final distance threshold from the model. Remaining inlier points are fitted to a final model. The final model is used to determine a geometric parameter of the HCF for use during quality control, splicing and/or fiber drawing.

### CROSS-REFERENCE TO RELATED APPLICATIONS

This application claims priority to, and the benefit of, U.S. Provisional Application Ser. No. 63/750,985, filed Jan. 29, 2025 and entitled “PROCESSING HOLLOW CORE FIBER IMAGES,” the entire contents of which are incorporated by reference herein in their entirety.

### BACKGROUND

Optical fibers conventionally refer to solid core optical fibers, comprising an annular cladding surrounding an inner circular core with a raised index of refraction. Recently a new class of optical fibers called hollow core fibers (HCFs) has been developed. Light is guided in a hollow central core, rather than in solid glass. Loss of HCFs is mainly determined by the design, geometry and longitudinal uniformity of the microstructure of the fiber. This fiber structure is popular for a variety of advanced applications in data centres, long-haul communications, and high-precision sensing.

Hollow core fibers are made by drawing down a suitable hollow core preform having a cross-sectional structure matching the intended refractive index profiled of the finished fiber. The glass preform is softened with heat, and then pulled or drawn from one end.

Fiber drawing results in fibers of a certain length, as determined by the drawing process. In order to make longer fibers, or to replace a portion of fiber with another one, splicing of fibers is used. Splicing involves joining two fiber ends together to ensure continuous light transmission. Accurate alignment and splicing of HCFs helps to maintain the performance and reliability of optical networks.

The embodiments described below are not limited to implementations which solve any or all of the disadvantages of known processing methods for images of hollow core fibers.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

Disclosed herein are image processing methods for images of hollow core fibers in order to determine geometric parameters of the imaged fiber. The parameters may be used to control a fiber drawing process, or to control a fiber splicing process.

A method for processing an image of a hollow core fiber, HCF, comprises accessing an image of a hollow core fiber. For an edge of a tube of the HCF, brightness of the image is used to detect points corresponding to the edge. The method further includes fitting an edge model function to detected edge points, and identifying an outlier point of the detected edge points wherein the outlier point is above a threshold distance from the fitted model. The outlier point is removed and the model is refitted to the remaining edge points. The method comprises iteratively identifying and removing subsequent outlier points and refitting the model to remaining edge points until all remaining edge points are inlier points below a final distance threshold from the model. Remaining inlier points are fitted to a final model. The final model is used to determine a geometric parameter of the HCF, wherein the geometric parameter is used during at least one of: quality control, splicing, fiber drawing.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic transverse cross-sectional view of an antiresonant hollow core fiber;

FIG. 2 is a schematic transverse cross-sectional view of a nested antiresonant hollow core fiber;

FIG. 3 is a schematic transverse cross-sectional view of a double nested antiresonant hollow core fiber;

FIG. 4 is a schematic diagram showing geometric features of a double nested antiresonant hollow core fiber;

FIG. 5A is a schematic diagram showing an image of a transverse cross-section of a doublenested nodeless antiresonant hollow core fiber;

FIG. 5B is shows changes in brightness of an image along a radial line from the center of a hollow core fiber;

FIG. 6 is a flow diagram of a method for processing an image of a hollow core fiber by iteratively fitting a model to an edge of the hollow core fiber;

FIG. 7 illustrates a flow diagram for iterative residual analysis used for outlier detection;

FIG. 8 is a flow diagram of a method for determining and using parameters of a hollow core fiber;

FIG. 9 is a flow diagram of a method for processing an image of a hollow core fiber by detecting circles in the image;

and

FIG. 10 illustrates an exemplary computing-based device in which image processing methods are implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples are constructed or utilized. The description sets forth the functions of the examples and the sequence of operations for constructing and operating the examples. However, the same or equivalent functions and sequences may be accomplished by different examples.

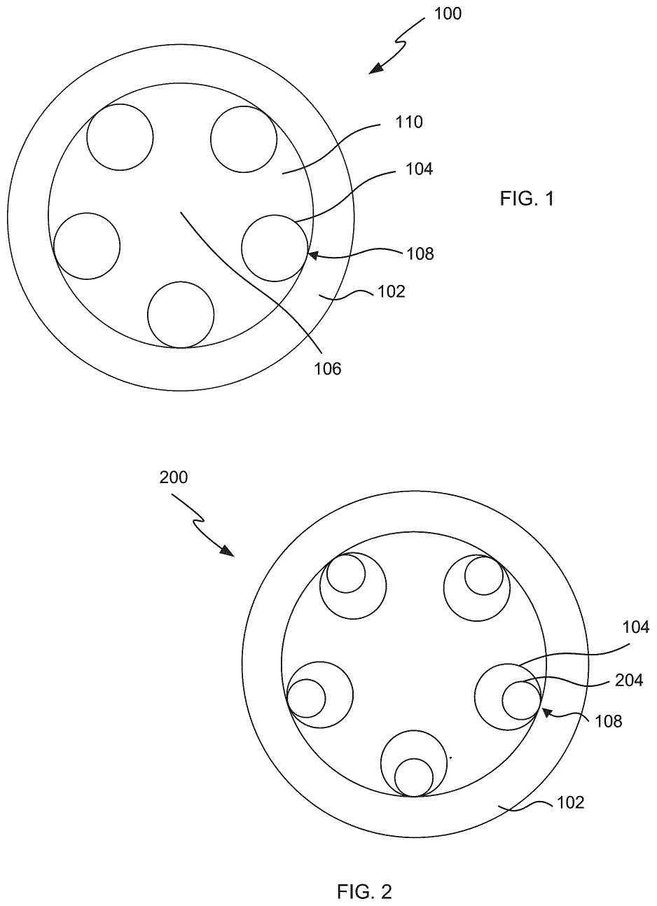

FIGS. 1-3 show schematic transverse cross-sectional views of three different examples of antiresonant hollow core fibers (ARFs). Light is guided in these fibers by an antiresonant optical effect. Each of the fibers 100, 200, 300 comprises a cladding capillary 102, a microstructure comprising a plurality of tubular microstructure capillaries 104, 204, 304 and a hollow core 106. As used herein, “tube” is interchangeable with “capillary”. The capillaries form a hierarchy with smaller capillaries arranged inside larger ones. Cladding capillary 102 forms the root of a hierarchical model and may be referred to as level 0. The cladding capillary 102 has a glass thickness that is typically much larger than that of the microstructure capillaries 104, 204, 304. In the first example, shown in FIG. 1, the microstructure comprises five capillaries 104 of similar cross-sectional size and shape, which are arranged inside the cladding capillary 102 in a single ring so that the longitudinal axes of each microstructure capillary 104 and of the cladding capillary 102 are substantially parallel. It is to be understood that other hollow core fiber designs include varying capillary sizes to achieve particular optical effects such as birefringence. The capillaries 104 form the first level in the hierarchy of capillaries within the ARF. Each microstructure capillary 104 is in contact with (e.g. bonded to) the inner surface of the cladding capillary 102 at an azimuthal location 108, such that the microstructure capillaries 104 are approximately evenly spaced around the inner circumference of the cladding capillary 102, and are also spaced apart from each other by gaps 110 (i.e. such that there is no contact between neighbouring microstructure first-level capillaries 104). Azimuthal location 108 in various scenarios extends over a range of angles. For each tube, there is an angle for start of contact and an angle for end of contact. An average azimuthal location may be determined as an average of these two angles. In some designs of ARF, the microstructure capillaries 104 may be positioned in contact with each other (in other words, not spaced apart as in FIG. 1), but spacing to eliminate this contact can improve the fiber's optical performance. The gaps 110 remove nodes that arise at the contact points between adjacent capillaries, and which tend to cause resonances in the transmission spectrum that result in high losses and degradation of other transmission properties of the hollow core fiber. Accordingly, fibers with spaced-apart cladding capillaries may be referred to as “nodeless antiresonant hollow core fibers”.

The arrangement of the cladding capillaries 104 in a ring around the inside of the tubular cladding capillary 102 creates a central space, cavity, or void within the fiber, also with its longitudinal axis parallel to those of the cladding capillary 102 and the cladding capillaries 104, which is the fiber's hollow core 106. The hollow core 106 is bounded by the inwardly facing parts of the outer surfaces of the microstructure capillaries 104. This is the core boundary, and the material (glass or polymer, for example) of the capillary walls that make up this boundary provides the required antiresonance optical guidance effect or mechanism. The cladding capillaries 104 have a thickness, t₁, at the core boundary which determines (sometimes along with other parameters) the wavelength for which antiresonant optical guiding occurs in the ARF.

In the second example, shown in FIG. 2, each first-level microstructure capillary 104 has a second-level, smaller capillary 204 nested inside it. In the particular example shown in FIG. 2 second-level capillary 204 is bonded to the inner surface of the first-level microstructure capillary 104. Often, capillaries 104 penetrate the cladding capillary 102 such that capillaries 204 are bonded to cladding capillary 102 rather than capillary 104. This scenario is depicted in FIG. 4. FIG. 2 shows the second-level capillary 204 bonded to the first-level capillary 104 at the same azimuthal location 108 as the point of bonding between the first-level microstructure capillary 104 and the cladding capillary 102. However, it is to be understood that the azimuthal location may vary. These additional smaller capillaries 204 can reduce the optical loss. ARF designs of this type, with secondary capillaries, may be referred to as “nested antiresonant nodeless fibers” (NANFs)(™).

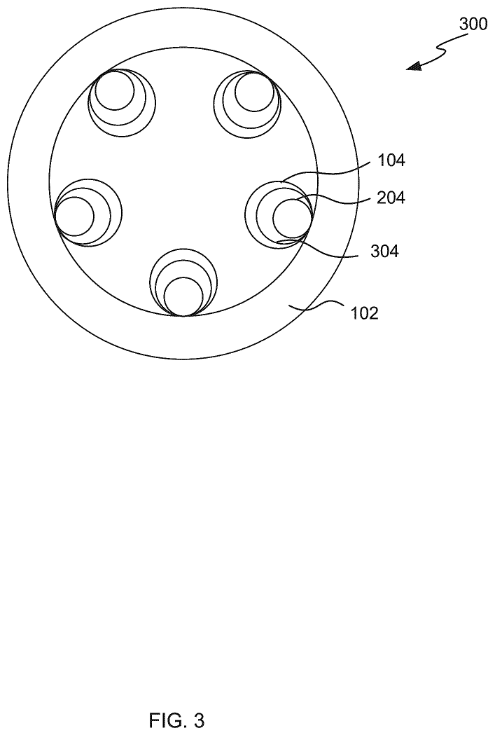

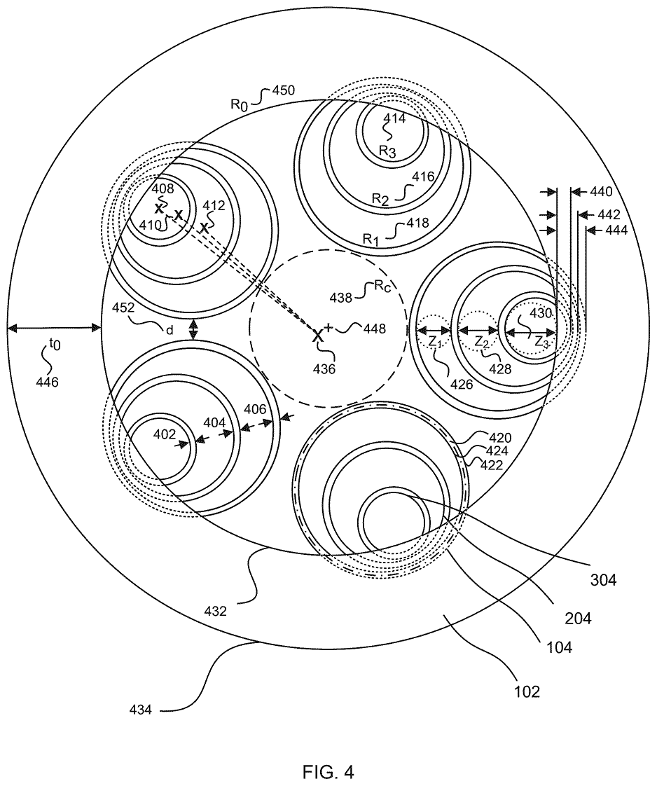

The third example, shown in FIG. 3, has smaller third-level capillaries 304, nested inside the second-level capillaries 204, which again are nested inside the first-level capillary 104. In the example shown in FIG. 2, each of the smaller capillaries 204, 304 is bonded to the inner surface of the immediately larger capillary. In this example, the smaller capillary 204 may be referred to as the second-level capillary and the smallest capillary 304 may be referred to as the third-level capillary. The third-level capillary 304 is bonded to the inner surface of the second-level capillary 204 and the second-level capillary 204 is bonded to the inner surface of the first-level capillary 104. ARF designs of this type, with three levels of nested capillaries may be referred to as “double-nested antiresonant nodeless fibers” (DNANFs). In yet further examples (not shown in the drawings) there may be a different configuration of microstructure capillaries. For example, there may be smaller further capillaries, nested within the third-level capillary 304 and/or there may be a plurality of second-level capillaries within each first-level capillary, each second-level capillary being bonded to the inner surface of the first-level capillary at a different azimuthal location and/or each first-level capillary may have an internal structure (e.g. one or more dividing walls).

All of the examples shown in FIGS. 1-3 comprise five first-level capillaries 104 and hence have five-fold rotational symmetry. Furthermore, all the cladding capillaries are approximately circular in cross-section. In other examples, there may be a different number of first-level capillaries surrounding the core (e.g. four, six, seven, eight, nine or ten) and/or the capillaries may not be of circular cross-section. Additionally, whilst in the examples of FIGS. 1-3, all the first-level capillaries 104 are of the same size and shape, in other examples, the first-level capillaries nested within the cladding capillary 102 may not all be the same size and/or shape.

FIGS. 1-3 are merely examples of ARFs, and many other ARF structures are known. The disclosure is not limited to the examples described above

Although it is not illustrated in the Figures, other types of hollow core fibers extend to those including any arbitrary number of nested elements and different resonator shapes that are arranged to provide a central hole surrounded by a plurality of peripheral voids extending longitudinally along the fiber length.

Light attenuation mechanisms typical of solid core fibers are generally not applicable to hollow core fibers and are replaced by new mechanisms. As such, optical loss in hollow core fibers is mainly determined by the design, geometry and longitudinal uniformity of the microstructure (e.g., in DNANF, by the size and thickness of resonators, or nested capillaries, defining the hollow core). These properties define the transmission window (the range of wavelengths which are transmitted) and its depth (how low the transmission loss is at those wavelengths).

Hollow core fibers can be made by drawing down a preform formed with the desired cross-sectional profile. So that the desired geometrical structure may be achieved, pressure is applied to voids during drawing of the fiber from a preform. The pressurization counteracts surface tension in the softened glass which otherwise can cause collapse of the voids and destruction of the intended structure. During the drawing process, various parameters are controlled so that the process results in fibers with the desired optical loss and geometric parameters. By measuring the geometric parameters of HCFs produced by a drawing process, the drawing process is monitored. If the resulting HCF does not have the desired geometric parameters, the drawing process can be altered and controlled so that the resulting fibers do have the desired parameters.

HCFs are often spliced together for example in order to increase fiber length or replace a portion of fiber. During splicing, misalignment of any kind disrupts the optimal pathway for light transmission through the fiber cores, significantly increasing splice loss. Proper alignment is important to ensure minimal splice loss and maintain the high performance of hollow core fibers in optical networks. In order to make sure that the core and the capillaries of both fibers are aligned properly, an accurate location for the core center and the exact position of the first-level capillaries of each fiber is required.

Optical properties such as optical loss of an HCF are determined by fiber geometry and optical properties may be computed based on measured geometric parameters of a fiber. For example, if geometric parameters are determined based on an image of a fiber, those parameters may be input into a computer model which outputs optical properties. Based on the optical output properties, fiber production may be altered and controlled, for example to improve the performance of the resulting fiber.

The present disclosure relates to accurate measurement of geometric features in a cross-sectional image of a hollow core fiber, particularly a fiber comprising an arrangement of capillaries such as tubular fibers (NANF and DNANF). As mentioned above, optical performance of the fiber is closely related to its geometric parameters such as core radius (R_{c}), gap sizes (d), resonator sizes (z) or tube wall thickness (t). Accurately determining geometric parameters allows optical performance to be modelled, and the fiber production process can be modified based on the model output to improve fiber performance. Additionally, applications such as fiber splicing require precise determination of the core centers of the fibers in order to align them. This is only possible when the microstructure parameters of both fibers are thoroughly characterized. Fiber drawing processes may also be monitored based on measurements taken from drawn HCFs. For example, measurements may indicate a problem with the drawing process which can then be fixed. Determining geometric parameters may also be used during quality control.

Methods described herein are applicable to any suitable image of an ARF such as an optical image or a scanning electron microscopy (SEM) image. Optical images obtained using a visible light microscope are typically easier and quicker to obtain than an SEM image. Meanwhile SEM images are typically of a higher resolution allowing more details of the microstructure to be imaged.

FIG. 4 shows geometric features and parameters of an example DNANF such as fiber 300 shown schematically in FIG. 3. The geometric features and parameters characterize the example fiber. In various scenarios, methods described herein include determining some or all of the parameters illustrated in FIG. 4, and/or determining further parameters not shown in FIG. 4. As in FIG. 3, the example fiber has three nesting levels, a third-level capillary 304 within the second-level capillary 204, nested within the first-level capillary 104, nested within the cladding capillary 102. The capillaries in the example are depicted as circles, but they are generally non-circular closed convex curves showing, for example, ellipticity. Each capillary 102, 104, 204, 304 has respective associated center coordinates (C₀, C₁, C₂, C₃) shown with crosses at 436, 412, 410, 408 respectively. Each capillary 102, 104, 204, 304 also has a respective associated internal edge and external edge, with both being a function of the angle and defined by the radial distance from the center coordinates. For example, capillary 104 has an internal edge 424 and external edge 422. Capillary 102 has an internal edge 432 and an external edge 434. If both internal and external edge are represented by a circle, the edges can alternatively be defined using an inradius (R₀, R₁, R₂, R₃) shown at 450, 418, 416, 414 respectively and a thickness (t₀, t₁, t₂, t₃) shown at 446, 406, 404, 402 respectively. The thickness of each capillary can vary along its circumference. Each capillary has an average edge with a radius that is in between the internal edge and the external edge and is also a function of the angle. For example, capillary 104 has an average edge 420 with a radius in between internal edge 424 and external edge 422. It is to be understood that each capillary has corresponding average, internal and external edges. Distances between capillaries (z₁, z₂, z₃) of different levels are shown at 426, 428, 430. In examples, these distances are defined as the diameter of the largest circle that fits inside the internal edge of a capillary without overlapping any other external edge of the geometry. At 452 a distance d is shown corresponding to the minimum distance between two first-level capillaries 104, also referred to as gap.

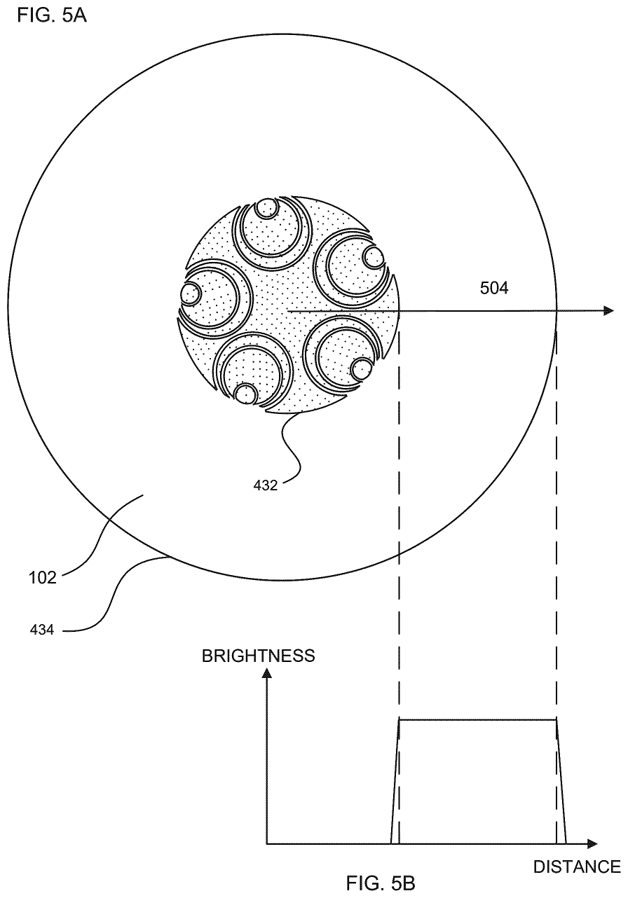

The cladding capillary 102 has an internal and external edge 432, 434 with internal and external angularly varying radii, respectively, and typically the cladding capillary 102 will be much thicker, compared to the smaller microstructure capillaries, than shown in FIG. 4 (e.g. as shown in FIG. 5A). The fiber also has a core center indicated with a cross at 448. The core radius R_{c} is shown at 438. In other examples, there are non-circular definitions of the core and it is to be understood that the disclosure is not limited to a circular core shape. Further parameters not shown in FIG. 4 include core-cladding concentricity error, which is the distance between the centers 436 of the cladding capillary 102 and the center 448 of a notional circle with radius R_{c} (or in further examples, another shape) which is, for example, defined as the largest circle that can be inscribed in the central void between the first-level capillaries without overlapping the external edges of any capillaries. It is to be understood that in further examples the core is defined in other suitable ways which may not comprise a circular shape. Another parameter shown in FIG. 4 is called overlap (δ₁, δ₂, δ₃) shown at 444, 442, 440 respectively, which is the radial overlap between a microstructure capillary and the cladding capillary. In other words, the external edges of the microstructure capillaries extend into the cladding capillary by an amount which is the overlap.

Disclosed herein are methods for determining some or all of the parameters depicted in FIG. 4 and/or described above from an image of a hollow core fiber such as a SEM or optical image. FIG. 5A is a schematic diagram showing an image of a transverse cross-section of a double-nested nodeless antiresonant hollow core fiber. As shown in FIG. 5A in an image of the HCF such as an optical or SEM image, glass regions are bright while void regions are dark. Void regions may be vacuum or gas filled. In FIG. 5A voids are shown as filled with dots (to represent dark regions of the image) and glass or polymer such as the material of the cladding capillary 102 is shown in white. As depicted schematically in FIG. 5A, brightness changes with radial distance from the center of an HCF. For example, brightness along the direction 504 is plotted at in FIG. 5B. The internal edge 432 of the cladding capillary 102 may be detected as a positive gradient in brightness, as brightness increases from dark to light. The external edge edge 434 of the cladding capillary 102 may be detected as a negative gradient in brightness, as brightness decreases with distance in the region of the external edge 434. Similar patterns in brightness will be observed along any radial line from the center of an HCF such as radial line 504. Radial line 504 does not pass through the microstructure of the example HCF shown in FIG. 5A but changes in brightness due to microstructure would be observed along other radial lines. In some scenarios, when determining the external and internal edges of the cladding capillary the radial line is analyzed inwards (i.e. from outside the fiber to inside the fiber). The external edge of the cladding capillary then corresponds to a positive gradient along this direction and the internal edge of the cladding capillary corresponds to a negative gradient. In some cases, the image may be transformed into polar coordinates. In these cases, image brightness is analyzed along rows of the resulting image, which correspond to radial lines.

Additionally or alternatively, a brightness threshold may be used to detect internal and external edges. For example, the threshold could be an average between a dark pixel value corresponding to a void region and a bright pixel value corresponding to a capillary region.

An image in various examples is loaded from a storage medium, which can be done directly from an image file or extracted from a database. Before initiating further processing, parameters may be retrieved from a file or database to configure the specific behavior of the process. An initial step involves denoising the image. This is beneficial as any noise present will be amplified during the gradient calculation for edge detection. Various noise reduction methods can be employed, including non-local means, total variation minimization, wavelet transform, and machine learning-based methods, all of which reduce noise while preserving image details necessary for accurate edge detection. In various examples, the first edge to be analyzed is the internal edge of the cladding capillary. To achieve this, an initial estimate for the center of the edge is provided. Depending on the image, this can be accomplished by locating the center or centroid of the image or by employing other suitable methods.

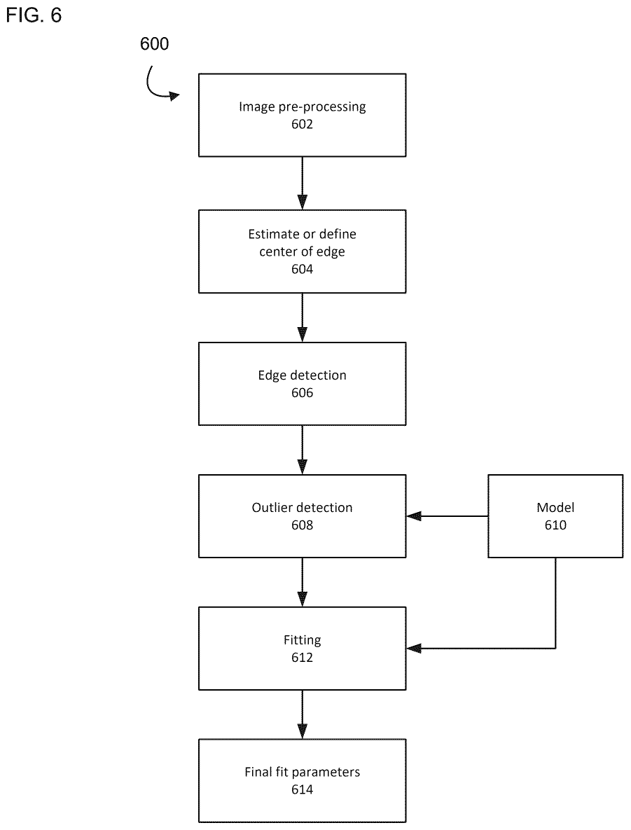

FIG. 6 is a flow diagram of a method 600 for processing an image of a hollow core fiber to detect an edge and fit a the datapoints to a mathematical model. At block 602, a series of image pre-processing steps is carried out, such as normalization and denoising. This can also include applying one or more masks to the image to focus on regions of interest. At block 604 a center coordinate for the internal edge is either defined or estimated. At block 606, edge points are detected using either threshold-based or gradient-based methods. In an example, it is desired to fit a model to the internal edge 432 of the cladding capillary. At block 608, the model function 610 is utilized to detect outliers within the edge points. At block 612, the remaining inliers are fitted to the model function 610 to obtain the final fit parameters 614. As shown in FIG. 5B, the internal edge 440 corresponds to change in brightness from dark to light.

As explained above, points corresponding to an edge are determined at 606. In various examples, roughly 1000 edge points are detected based on gradient in brightness. These may be derived from around 1000 radial lines. In an example, 720 angles between 0 and 360 degrees are chosen so that the radial lines have an azimuthal distance of 0.5 degrees. At block 610, a model function for the edges is defined. In some examples tolerances are also defined. In various scenarios the model function is a Fourier series

$$r ( θ ) = {{\sum }_{m}}^{N} {A}_{m} cos m θ + {B}_{m} sin m θ ,$$

where m denotes summation index, also referred to as harmonic, N denotes the order of the series, and Aₘ and Bₘ are fit parameters.

At block 608, the model is used to identify outliers within the edge detected at 606. For example, an edge which is roughly circular may be expressed in terms of radial distance as a sum of sines and cosines of an angular coordinate, θ. The Fourier series may be expressed in polar coordinates or cartesian coordinates. In further examples, the model function is any other suitable function. A Fourier series is parameterized with Fourier parameters. In various examples, a Fourier series characterizing an edge within an HCF may have more than 10 harmonics, i.e. more than 20 fit parameters. Fourier series provide an accurate representation of periodic functions and provide an efficient way to characterize the shape of an edge within an HCF. They furthermore allow geometrically meaningful interpretation, e.g. concentricity error between internal and external capillary edge, or ellipticity of a capillary. As shown in FIG. 5A, edges within an HCF are often roughly, but not perfectly, circular. This non-circularity arises as a result of tube production and/or fiber production, for example as a result of joins between the microstructure capillary and the cladding capillary. A Fourier series model with an appropriate order captures non-circularity in the shape of the edge resulting in more accurate characterization of HCF geometry.

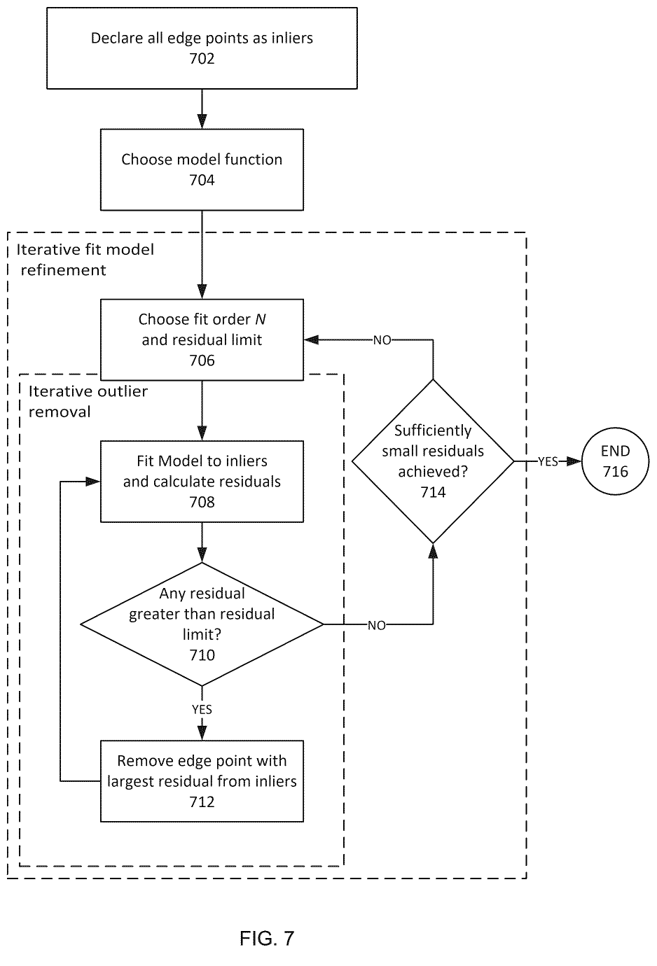

During the edge detection process, once the edge points are obtained, identifying and removing outliers is performed to enhance the accuracy of the final model fitting. Various outlier detection methods can be employed, including iterative residual analysis, random sample consensus (RANSAC), isolation forest, histogram-based outlier detection, and machine-learning based techniques. In various examples, outliers are points above a threshold distance from the model. FIG. 7 illustrates a flow diagram for iterative residual analysis used for outlier detection such as outlier detection 608. Initially, at blocks 702 and 704, all edge points are categorized as inliers (points below a threshold distance from the model), and a model function is established. The iterative model refinement begins with setting an order for the Fourier series (N) and a residual limit at block 706. As used herein, a residual limit refers to a threshold distance above which a point is determined to be an outlier and below which a point is determined to be an inlier. This may also be referred to as a limit. As shown at 706, the residual limit which is used to identify outliers and inliers may change between iterations. Typically, the refinement process starts with a lower fit order and a higher residual limit. At block 708, the model is fitted to the inliers, and the residuals (in other words distances) between the model predictions and the actual edge points are calculated. If any residuals exceed the residual limit (i.e. threshold) 710, the edge point with the largest residual is removed from the list of inliers at block 712. This iterative process is repeated from block 708 until no residuals exceed the residual limit. At block 714, there is a check to determine whether the residuals are sufficiently small (e.g. below a second threshold). If the residuals are not sufficiently small, the fit order may be increased, and the residual limit (threshold) may be decreased as shown at block 706. During iterative identification and removal of outliers, different thresholds may be used at different iterations. Additionally or alternatively, different fit orders may be used at different iterations. If it is determined at block 714 that the residuals are sufficiently small, the process ends at 716. The outlier removal process is then repeated with the updated list of inliers, fit order, and residual limit until sufficiently small residuals are achieved.

The edge detected by method 600 in various scenarios is an internal 432 or an external 434 edge of a cladding capillary 102 of an HCF. An internal 432 or external 434 edge of the cladding capillary 102 can be detected in an optical or an SEM image of the fiber. This is on account of the dimensions of the HCF and image resolution. The resolution of an optical image is limited by diffraction and therefore in the magnitude of a few hundreds of nanometers while the resolution of a SEM image can be a few nanometers. Because of this, internal and external edges of the cladding capillary 102 are resolved in an optical image but internal and external edges of tubular cladding capillaries such as 104, 204, 304 are not resolved in an optical image. The lower resolution of the optical image means that internal and external edges of the microstructure capillaries are blurred in an optical image. However, method 600 is suitable for identifying and characterizing edges of microstructure capillaries in SEM images because of the higher resolution of SEM images. In various examples, to characterize edges of microstructure capillaries the image may be cropped or masked in the region of a tubular cladding capillary before using method 600.

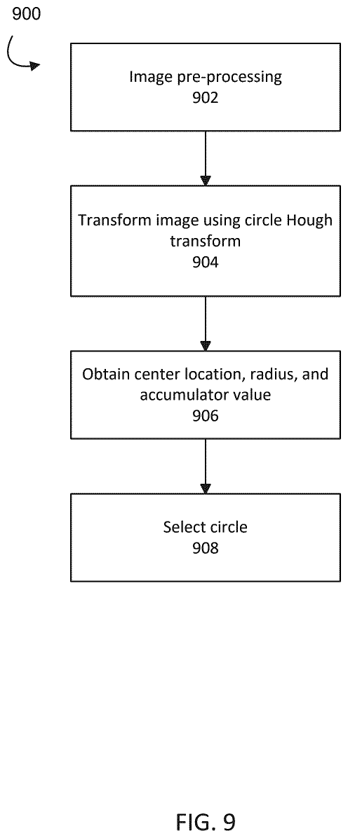

In various examples method 600 is used to detect and characterize both the internal and external edges 432 and 434 of cladding capillary 102. Once the edges are detected, they can be used to apply a mask to remove the cladding 102 from an image of the fiber. The cladding 102 may be masked from an SEM or optical image of the fiber. This allows the geometry of the microstructure to be measured without the cladding capillary causing errors in measurements. Otherwise, the presence of the cladding capillary may cause difficulties in extracting features of the microstructure. Masking the cladding capillary 102 reduces outliers and reduces the risk that features of the microstructure are mistaken for feature of the cladding capillary and vice versa. Also, as described below for example with reference to FIG. 6, the microstructure may be measured by detecting circles in the image. Masking the cladding capillary means circles corresponding to the cladding capillary are not detected making measuring the microstructure more accurate and reliable Depending on image resolution, image 600 may be used to extract geometric parameters relating to the microstructure capillaries for example if the image is an SEM image. In other examples, the method described below with reference to FIG. 9 is used to extract geometric parameters relating to the microstructure capillaries of the HCF. In this way, the methods of FIGS. 6 and 9 may be performed together or may be performed independently.

FIG. 9 is a flow diagram of a method 900 for processing an image of a hollow core fiber by detecting circles in the image. The method uses a circle Hough transform (CHT) which is an image processing technique for detecting circles in images. The circle Hough transform detects circles in images even when the circles are imperfect or partially obscured.

At block 902, before detecting circles using CHT, the image is pre-processed for example in the following ways. The image is normalized such that the brightness of each pixel in the image is within a range from zero to one, or any other suitable range. In various scenarios the image is binarized such that any pixel with a brightness above a threshold brightness is set to a value of 1 and any pixel with a brightness below the threshold value is set to a value of 0. The binarized image is then skeletonized, which reduces the width of features within the image to one pixel. To skeletonize a binary image, pixels are iteratively removed from the boundary of an object in the image without breaking its connectivity until the object is reduced to a skeleton which is one pixel wide.

The skeletonized image is transformed using the circle Hough transform at block 904. The circle Hough transform transforms the image into a parameter space defined by center coordinates and radius of a circle. Potential circles are generated by voting in parameter space and an accumulator score for each circle represents the number of votes for that circle.

At block 906, center location, radius and accumulator value are obtained for each detected circle. At block 908 a circle is selected based on the accumulator value. Maxima in the accumulator score correspond to the most likely circle parameters (center location and radius). In various examples, selected circles are circles with an accumulator value above a threshold value. In further examples, circles are selected using a test for nesting and/or constraints related to known HCF geometry. For example, the imaged HCF in FIG. 5A is a double-nested antiresonant hollow core fiber with 5-fold rotational symmetry. It is therefore expected that 15 circles will be selected in the microstructure and that the 15 circles are divided into five angular groups of three nested circles. In an example, first-level capillaries 104 are selected first, and are identified as being circles with the largest radius. Once the radius and center coordinates are known for each first-level capillary 104 the nested second-level capillaries 204 are identified by having center coordinates within capillaries 104 and a smaller radius. Subsequently, third-level capillaries 304 are identified as having center coordinates within second-level capillaries 204 and a center radius. Circles detected using the circle Hough transform are in various examples used as shapes to mask a particular capillary and to focus on that capillary.

As described above, circles are selected as corresponding to microstructure capillaries such as 104, 204, 304 using method 900. Circles detected using the circle Hough transform do not have a thickness. Thickness of cladding capillaries (406, 404, 402 in FIG. 4) is sometimes required to provide input or feedback to a process such as a fiber splicing process, a drawing process or other fiber production process. In these scenarios, thickness of tubular cladding capillaries detected using method 900 may be determined using constraints. For example, known dimensions of the preform used to produce the fiber mean that the thickness can be calculated using conservation of mass.

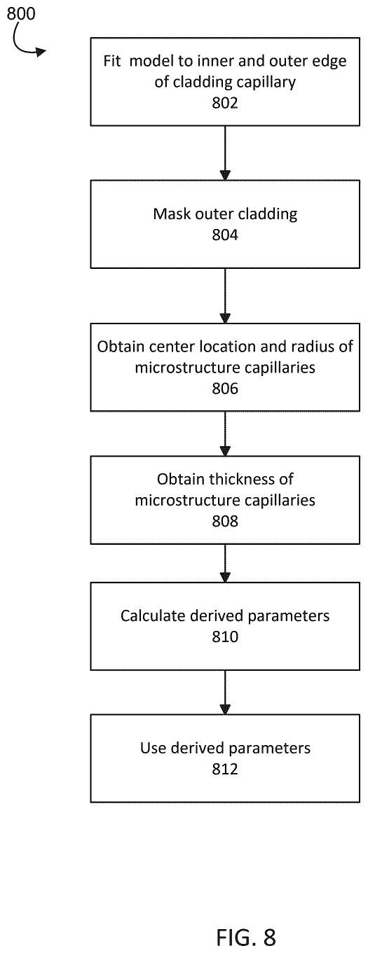

FIG. 8 is a flow diagram of a method for determining and using parameters of a hollow core fiber. At block 802, a model is fit to the internal and external edge of the cladding capillary 102. In various scenarios the model is obtained using method 600 in FIG. 6. The model may be a Fourier series which takes into account shapes which deviate from a circle, i.e. non-circularity. At block 804, the cladding capillary 102 is masked from the image using the models obtained at block 802. At block 806, center locations and radii of tubular cladding capillaries are obtained for example using method 900 described with reference to FIG. 9. The thickness of the microstructure capillaries is obtained at block 808 for example using conservation of mass and information relating to the preform and drawing process, or from modelling results. Alternatively, this information is obtained using method 600 from FIG. 6 but this requires higher image resolution and is more time consuming. Based on these measurements, derived parameters such as some or all of the parameters mentioned with reference to FIG. 4 are determined. At block 812, the obtained parameters are used for example to control a drawing process or a splicing process.

Example derived parameters include but are not limited to: core size, gap, relative resonator sizes z/Rc, wall thickness t, overlaps, core-cladding concentricity error, and various metrics for asymmetry. The core size may, in some examples, be defined as the largest circle, with radius Rc, that can be inscribed in the central void between the first-level capillaries without overlapping the external edges of any capillaries. The gap represents the minimum distance between two adjacent first-level capillaries. The relative resonator size is characterized by the ratio between the size of a resonator z and the core radius. The wall thickness is calculated as the difference between the radius of the external edge and the internal of a capillary. The overlap of a capillary is defined as the maximum distance between the external edge of the capillary and the internal edge of the cladding capillary. The core-cladding concentricity error is defined as the distance between the center coordinates of the cladding capillary and the inscribed core circle. Asymmetry quantifies the similarity between the capillaries within a nesting level, with various metrics applicable for defining asymmetry, such as the asymmetry of the gaps or the diameter of all first-level capillaries.

In one example, 3 or 4 samples of fiber are taken per draw during the drawing of the preform to form the fiber. Each sample is imaged and the image is processed according to the method 800 described with reference to FIG. 8. The results of the image processing, in terms of the geometric parameters of the fiber, are used as inputs to optimize draw parameters and the pressurization of the capillaries. For subsequent draws, if issues are detected in the images, the fiber drawing process is adjusted. Alternatively, if the image processing results indicate that the fiber possesses the desired geometrical properties, the fiber is selected for deployment; otherwise, the fiber is rejected. In another embodiment, the determined centers of the core and capillaries of two fibers are used to ensure the fibers are translationally and rotationally aligned before splicing, thereby improving splicing quality and resulting in reduced loss. In yet another example, the obtained parameters are used as inputs to a process that outputs optical properties of the fiber, such as finite element simulation, surrogate models, or neural networks. Based on the output, certain HCFs may be selected for production and use in a particular scenario.

The methods described in this disclosure operate in an unconventional manner to achieve accurate and efficient measurement of hollow core fiber geometry, which can be used to improve a process such as splicing or drawing.

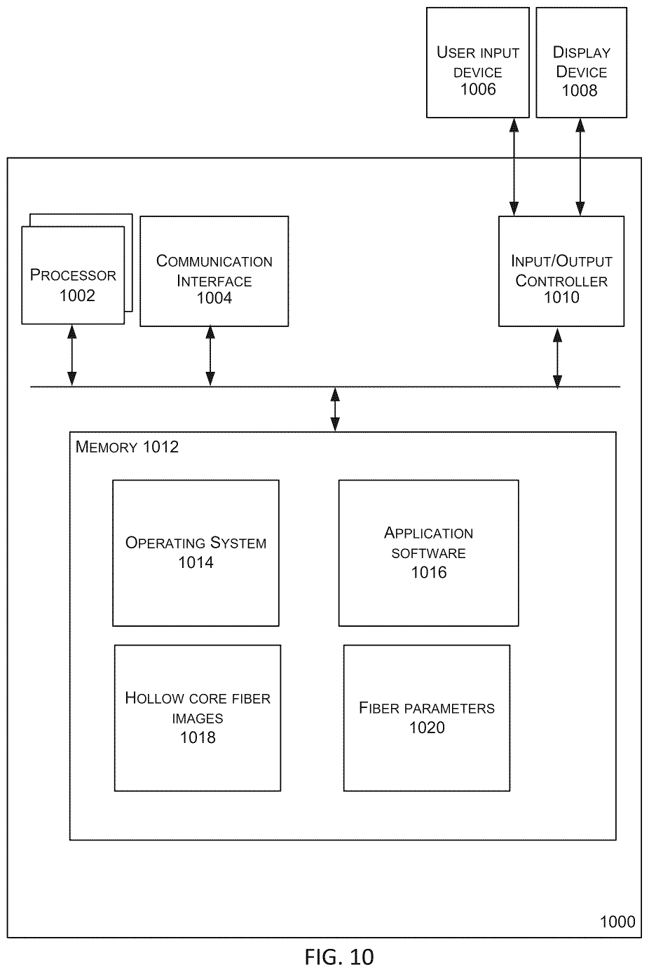

FIG. 10 illustrates various components of an exemplary computing-based device 900 which are implemented as any form of a computing and/or electronic device, and in which methods of processing an image of an HCF are implemented in some examples. In some examples, the computing-based device 1000 is a general-purpose computer that is activated or reconfigured by a computer program stored in the computer. In other examples the computing-based device is specially constructed for the intended purpose.

Computing-based device 1000 comprises one or more processors 1002 which are microprocessors, controllers or any other suitable type of processors for processing computer executable instructions to control the operation of the device in order to process an image of an HCF. The processors 1002 may include at least one general-purpose processing device such as a central processing unit, microprocessor, complex instruction set computing (CISC) microprocessor, reduced instruction set computing (RISC) microprocessor, or other general-purpose processing device. In some examples, for example where a system on a chip architecture is used, the processors 1002 include one or more special-purpose processing device such as a fixed function block (also referred to as an accelerator) which implements a part of the method of image processing in hardware (rather than software or firmware). The special-purpose processing device may be configured to execute instructions for performing the operations and methods described herein. Platform software comprising an operating system 1014 or any other suitable platform software is provided at the computing-based device to enable application software 1016 to be executed on the device. In various examples, software application data 1016 is stored in memory 1012. In further examples, also stored in memory 1012 are hollow core fiber images 1018 such as the image depicted in FIG. 5A and fiber parameters 1020 extracted from images 1018 using the methods described herein. Sometimes, hollow core fiber images are received via communication interface 1004 or input/output controller 1010.

The computer executable instructions are provided using any computer-readable media that is accessible by computing based device 1000. Computer-readable media includes, for example, computer storage media such as memory 1012 and communications media. Computer storage media, such as memory 1012, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 1012) is shown within the computing-based device 1000 it will be appreciated that the storage is, in some examples, distributed or located remotely and accessed via a network or other communication link (e.g. using communication interface 1004).

The computing-based device 1000 also comprises an input/output controller 1010 arranged to output display information to a display device 1008 which may be separate from or integral to the computing-based device 1000. The display information may provide a graphical user interface. The input/output controller 1010 is also arranged to receive and process input from one or more devices, such as a user input device 1006 (e.g. a mouse, keyboard, camera, microphone or other sensor). In some examples the user input device 1006 detects voice input, user gestures or other user actions and provides a natural user interface (NUI). In an embodiment the display device 1008 also acts as the user input device 1006 if it is a touch sensitive display device. The input/output controller 1010 outputs data to devices other than the display device in some examples, e.g. a locally connected printing device (not shown in FIG. 10).

Any of the input/output controller 1010, display device 1008 and the user input device 1006 may comprise NUI technology which enables a user to interact with the computing-based device in a natural manner, free from artificial constraints imposed by input devices such as mice, keyboards, remote controls and the like. Examples of NUI technology that are provided in some examples include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that are used in some examples include intention and goal understanding systems, motion gesture detection systems using depth cameras (such as stereoscopic camera systems, infrared camera systems, red green blue (rgb) camera systems and combinations of these), motion gesture detection using accelerometers/gyroscopes, facial recognition, three dimensional (3D) displays, head, eye and gaze tracking, immersive augmented reality and virtual reality systems and technologies for sensing brain activity using electric field sensing electrodes (electro encephalogram (EEG) and related methods).

Alternatively, or in addition, the functionality described herein is performed, at least in part, by one or more hardware logic components. For example, and without limitation, illustrative types of hardware logic components that are optionally used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

Alternatively or in addition to the other examples described herein, examples include any combination of the following:
Clause A. A method for processing an image of a hollow core fiber, HCF, the method comprising: accessing an image of a hollow core fiber; for an edge of a tube of the HCF: using brightness of the image to detect points corresponding to the edge; fitting an edge model function to the detected edge points; identifying an outlier point of the detected edge points wherein the outlier point is above a threshold distance from the fitted model; removing the outlier point and refitting the model to remaining edge points; iteratively identifying and removing subsequent outlier points and refitting the model to remaining edge points until all remaining edge points are inlier points below a final distance threshold from the model; fitting the remaining inlier points to a final model; and using the final model to determine a geometric parameter of the HCF, wherein the geometric parameter is used during at least one of: quality control, splicing, fiber drawing.
Clause B. The method of clause A wherein the model is a Fourier series.
Clause C. The method of clause A or B wherein the tube of the HCF is a cladding capillary and wherein the edge comprises an internal edge and the method is repeated for an external edge of the cladding capillary.
Clause D. The method of clause C further comprising using a final model of the internal edge and/or a final model of the external edge to mask the cladding capillary of the HCF from the image.
Clause E. The method of clause D further comprising: transforming the image using a circle Hough transform; determining a center location, radius and accumulator value for each of one or more circles detected using the transformed image; and selecting, from the detected circles, at least one circle corresponding to a tubular cladding capillary of the HCF.
Clause F. The method of clause E wherein the selecting is based on accumulator value.
Clause G. The method of clause E or clause F wherein the selecting comprises using a constraint comprising information about the number of tubular cladding capillaries in the HCF and information about nesting of the tubular cladding capillaries in the HCF.
Clause H. The method of any of clauses E to G further comprising determining the thickness of the tubular cladding capillary using conservation of mass.
Clause I. The method of any of clauses E to H further comprising, prior to transforming the image: normalizing the image; binarizing the image; and skeletonizing the image.
Clause J. The method of any preceding clause wherein using brightness of the image to detect points corresponding to the edge comprises: determining image brightness along a plurality of radial lines from the center of the image; calculating image brightness gradient along each radial line; and identifying a point along each radial line wherein the brightness gradient is a maximum positive gradient or maximally negative gradient, or wherein using brightness of the image to detect points corresponding to the edge comprises: determining image brightness along a plurality of radial lines from the center of the image; and identifying a point along each radial line wherein the brightness exceeds a threshold brightness.
Clause K. The method of any preceding clause wherein the hollow core fiber comprises a transverse cross-sectional structure comprising a hollow core surrounded by a plurality of capillaries defining a plurality of voids encased by a cladding capillary and wherein the structure of the hollow core fiber is an antiresonant hollow core fiber structure comprising: a plurality of first-level microstructure capillaries arranged in a ring around an inner surface of the cladding capillary, wherein the ring of first-level capillaries defines the hollow core and the channel of the first-level capillary defines a void of the plurality of voids; a plurality of second-level capillaries each nested inside one of the plurality of first-level capillaries, wherein the channel of the second-level capillary defines a void of the plurality of voids; and a plurality of third-level capillaries each nested inside one of the plurality of second-level capillaries, wherein the channel of the third-level capillary defines a void of the plurality of voids.
Clause L. An apparatus comprising: a processor; a memory storing instructions that, when executed by the processor, perform a method comprising: accessing an image of a hollow core fiber; for an edge of a tube of the HCF: using brightness of the image to detect points corresponding to the edge; fitting an edge model function to detected edge points; identifying an outlier point of the detected edge points wherein the outlier point is above a threshold distance from the fitted model; removing the outlier point and refitting the model to remaining edge points; iteratively identifying and removing subsequent outlier points and refitting the model to remaining edge points until all remaining edge points are inlier points below a final distance threshold from the model; fitting the remaining inlier points to a final model; and using the final model to determine a geometric parameter of the HCF, wherein the geometric parameter is used during at least one of: quality control, splicing, fiber drawing.
Clause M. The apparatus of clause L wherein the model is a Fourier series.
Clause N. The apparatus of clause L or clause M wherein the tube of the HCF is an cladding capillary and wherein the edge comprises an internal edge and wherein the method is repeated for an external edge of the cladding capillary, and wherein the method further comprises using a final model of the internal edge and a final model of the external edge to mask the cladding capillary of the HCF from the image.
Clause O. The apparatus of clause N wherein the method further comprises: transforming the image using a circle Hough transform; determining a center location, radius and accumulator value for each of one or more circles detected using the transformed image; and selecting, from the detected circles, at least one circle corresponding to a microstructure capillary of the HCF.
Clause P. The apparatus of clause L wherein using brightness of the image to detect points corresponding to the edge comprises: determining image brightness along a plurality of radial lines from the center of the image; calculating image brightness gradient along each radial line; and identifying a point along each radial line wherein the brightness gradient is a maximum positive gradient or maximally negative gradient, or wherein using brightness of the image to detect points corresponding to the edge comprises: determining image brightness along a plurality of radial lines from the center of the image; and identifying a point along each radial line wherein the brightness exceeds a threshold brightness.
Clause Q. A method for processing an image of a hollow core fiber, the method comprising: accessing an image of a hollow core fiber; obtaining a model for a shape of an internal edge and an external edge of a cladding capillary of the HCF by: using a gradient of brightness of the image to detect points corresponding to the edge; iteratively removing subsequent outlier points and refitting subsequent models until all remaining points are inlier points wherein inlier points are below a threshold distance from a final model; using the internal and external edge models to mask the cladding capillary from the image of the HCF; obtaining center coordinates and a radius for each microstructure capillary of the HCF by: transforming the image using a circle Hough transform; determining a center location, radius and accumulator value for a circle detected using the transformed image; selecting the circle, wherein the circle corresponds to a microstructure capillary of the HCF; determining the thickness of each tubular cladding capillary using conservation of mass; and wherein the obtained center coordinates, radius, and thickness of each tubular cladding capillary and/or derived parameters and/or edge models are used during at least one of: quality control, splicing, fiber drawing.
Clause R. The method of clause Q wherein the hollow core fiber comprises a transverse cross-sectional structure comprising a hollow core surrounded by a plurality of capillaries defining a plurality of voids encased by a cladding capillary and wherein the structure of the hollow core fiber is an antiresonant hollow core fiber structure comprising: a plurality of first-level tubular cladding capillaries arranged in a ring around an inner surface of the cladding capillary, wherein the ring of first-level capillaries defines the hollow core and the channel of the first-level capillary defines a void of the plurality of voids; a plurality of second-level capillaries each nested inside one of the plurality of first-level capillaries, wherein the channel of the second-level capillary defines a void of the plurality of voids; and a plurality of third-level tubular cladding capillaries each nested inside one of the plurality of second-level capillaries, wherein the channel of the third-level capillary defines a void of the plurality of voids.
Clause S. The method of clause Q wherein using brightness of the image to detect points corresponding to the edge comprises: determining image brightness along a plurality of radial lines from the center of the image; calculating image brightness gradient along each radial line; and identifying a point along each radial line wherein the brightness gradient is a maximum positive gradient or maximally negative gradient, or wherein using brightness of the image to detect points corresponding to the edge comprises: determining image brightness along a plurality of radial lines from the center of the image; and identifying a point along each radial line wherein the brightness exceeds a threshold brightness.
Clause T. The method of clause Q wherein the model for the shape of the internal edge and the model for the shape of the external edge are Fourier series models.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

What is claimed is:

1. A method for processing an image of a hollow core fiber, HCF, the method comprising:
accessing an image of a hollow core fiber;
for an edge of a tube of the HCF:
using brightness of the image to detect points corresponding to the edge;
fitting an edge model function to the detected edge points;
identifying an outlier point of the detected edge points wherein the outlier point is above a threshold distance from the fitted model;
removing the outlier point and refitting the model to remaining edge points;
iteratively identifying and removing subsequent outlier points and refitting the model to remaining edge points until all remaining edge points are inlier points below a final distance threshold from the model;
fitting the remaining inlier points to a final model; and
using the final model to determine a geometric parameter of the HCF, wherein the geometric parameter is used during at least one of: quality control, splicing, fiber drawing.

2. The method of claim 1 wherein the model is a Fourier series.

3. The method of claim 1 wherein the tube of the HCF is a cladding capillary and wherein the edge comprises an internal edge and the method is repeated for an external edge of the cladding capillary.

4. The method of claim 3 further comprising using a final model of the internal edge and/or a final model of the external edge to mask the cladding capillary of the HCF from the image.

5. The method of claim 4 further comprising:
transforming the image using a circle Hough transform;
determining a center location, radius and accumulator value for each of one or more circles detected using the transformed image; and
selecting, from the detected circles, at least one circle corresponding to a tubular cladding capillary of the HCF.

6. The method of claim 5 wherein the selecting is based on accumulator value.

7. The method of claim 5 wherein the selecting comprises using a constraint comprising information about the number of tubular cladding capillaries in the HCF and information about nesting of the tubular cladding capillaries in the HCF.

8. The method of claim 5 further comprising determining the thickness of the tubular cladding capillary using conservation of mass.

9. The method of claim 5 further comprising, prior to transforming the image: normalizing the image; binarizing the image; and skeletonizing the image.

10. The method of claim 1 wherein using brightness of the image to detect points corresponding to the edge comprises:
determining image brightness along a plurality of radial lines from the center of the image;
calculating image brightness gradient along each radial line; and
identifying a point along each radial line wherein the brightness gradient is a maximum positive gradient or maximally negative gradient,
or wherein using brightness of the image to detect points corresponding to the edge comprises:
determining image brightness along a plurality of radial lines from the center of the image; and
identifying a point along each radial line wherein the brightness exceeds a threshold brightness.

11. The method of claim 1 wherein the hollow core fiber comprises a transverse cross-sectional structure comprising a hollow core surrounded by a plurality of capillaries defining a plurality of voids encased by a cladding capillary and wherein the structure of the hollow core fiber is an antiresonant hollow core fiber structure comprising:
a plurality of first-level microstructure capillaries arranged in a ring around an inner surface of the cladding capillary, wherein the ring of first-level capillaries defines the hollow core and the channel of the first-level capillary defines a void of the plurality of voids;
a plurality of second-level capillaries each nested inside one of the plurality of first-level capillaries, wherein the channel of the second-level capillary defines a void of the plurality of voids; and
a plurality of third-level capillaries each nested inside one of the plurality of second-level capillaries, wherein the channel of the third-level capillary defines a void of the plurality of voids.

12. An apparatus comprising:
a processor;
a memory storing instructions that, when executed by the processor, perform a method comprising:
accessing an image of a hollow core fiber;
for an edge of a tube of the HCF:
using brightness of the image to detect points corresponding to the edge;
fitting an edge model function to detected edge points;
identifying an outlier point of the detected edge points wherein the outlier point is above a threshold distance from the fitted model;
removing the outlier point and refitting the model to remaining edge points;
iteratively identifying and removing subsequent outlier points and refitting the model to remaining edge points until all remaining edge points are inlier points below a final distance threshold from the model;
fitting the remaining inlier points to a final model; and
using the final model to determine a geometric parameter of the HCF, wherein the geometric parameter is used during at least one of: quality control, splicing, fiber drawing.

13. The apparatus of claim 12 wherein the model is a Fourier series.

14. The apparatus of claim 12 wherein the tube of the HCF is an cladding capillary and wherein the edge comprises an internal edge and wherein the method is repeated for an external edge of the cladding capillary, and wherein the method further comprises using a final model of the internal edge and a final model of the external edge to mask the cladding capillary of the HCF from the image.

15. The apparatus of claim 14 wherein the method further comprises:
transforming the image using a circle Hough transform;
determining a center location, radius and accumulator value for each of one or more circles detected using the transformed image; and
selecting, from the detected circles, at least one circle corresponding to a microstructure capillary of the HCF.

16. The apparatus of claim 12 wherein using brightness of the image to detect points corresponding to the edge comprises:
determining image brightness along a plurality of radial lines from the center of the image;
calculating image brightness gradient along each radial line; and
identifying a point along each radial line wherein the brightness gradient is a maximum positive gradient or maximally negative gradient,
or wherein using brightness of the image to detect points corresponding to the edge comprises:
determining image brightness along a plurality of radial lines from the center of the image; and
identifying a point along each radial line wherein the brightness exceeds a threshold brightness.

17. A method for processing an image of a hollow core fiber, the method comprising:
accessing an image of a hollow core fiber;
obtaining a model for a shape of an internal edge and an external edge of a cladding capillary of the HCF by:
using a gradient of brightness of the image to detect points corresponding to the edge;
iteratively removing subsequent outlier points and refitting subsequent models until all remaining points are inlier points wherein inlier points are below a threshold distance from a final model;
using the internal and external edge models to mask the cladding capillary from the image of the HCF;
obtaining center coordinates and a radius for each microstructure capillary of the HCF by:
transforming the image using a circle Hough transform;
determining a center location, radius and accumulator value for a circle detected using the transformed image;
selecting the circle, wherein the circle corresponds to a microstructure capillary of the HCF;
determining the thickness of each tubular cladding capillary using conservation of mass; and
wherein the obtained center coordinates, radius, and thickness of each tubular cladding capillary and/or derived parameters and/or edge models are used during at least one of: quality control, splicing, fiber drawing.

18. The method of claim 17 wherein the hollow core fiber comprises a transverse cross-sectional structure comprising a hollow core surrounded by a plurality of capillaries defining a plurality of voids encased by a cladding capillary and wherein the structure of the hollow core fiber is an antiresonant hollow core fiber structure comprising:
a plurality of first-level tubular cladding capillaries arranged in a ring around an inner surface of the cladding capillary, wherein the ring of first-level capillaries defines the hollow core and the channel of the first-level capillary defines a void of the plurality of voids;
a plurality of second-level capillaries each nested inside one of the plurality of first-level capillaries, wherein the channel of the second-level capillary defines a void of the plurality of voids; and
a plurality of third-level tubular cladding capillaries each nested inside one of the plurality of second-level capillaries, wherein the channel of the third-level capillary defines a void of the plurality of voids.

19. The method of claim 17 wherein using brightness of the image to detect points corresponding to the edge comprises:
determining image brightness along a plurality of radial lines from the center of the image;
calculating image brightness gradient along each radial line; and
identifying a point along each radial line wherein the brightness gradient is a maximum positive gradient or maximally negative gradient,
or wherein using brightness of the image to detect points corresponding to the edge comprises:
determining image brightness along a plurality of radial lines from the center of the image; and
identifying a point along each radial line wherein the brightness exceeds a threshold brightness.

20. The method of claim 17 wherein the model for the shape of the internal edge and the model for the shape of the external edge are Fourier series models.
